(19) United States
(12) Patent Application Publication
(10) Pub. No.: US 2007/0140254 A1
(43) Pub. Date: Jun. 21, 2007

(54) Method for packeting time-synchronous data during transmission in a packet data network

(76) Inventor: Walter Tuppa, Wein (AT)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/580,998

(22) PCT Filed: Nov. 10, 2004
(86) PCT No.: PCT/EP04/12737

§ 371 Date: Mar. 7, 2007

(30) Foreign Application Priority Data
Nov. 27, 2003 (EP) 03027207.4

(51) Int. Cl. H04L 12/56; H04B 7/212

(52) U.S. Cl. 370/395.4; 370/442

(57) ABSTRACT

The invention relates to a method and device for packeting time-synchronous data during transmission in a packet data network. Several time-synchronous links exist in said packet data network, for which data packets are periodically sent in a recurrent manner. According to the invention, the beginning of data transmission of a link is selected in such a way that the data packets of various links are distributed in relation to time in an evenly distributed manner as possible. If transmission links with said distributed data packets are combined to form a transmission link, said data packets are subject to little or no delay.

### CROSS REFERENCE TO RELATED APPLICATIONS

This application is the US National Stage of International Application No. PCT/EP2004/012737, filed Nov. 10, 2004 and claims the benefit thereof. The International Application claims the benefits of European application No. 03027207.4 filed Nov. 27, 2003, both applications are incorporated by reference herein in their entirety.

### FIELD OF THE INVENTION

The invention relates to a method for packeting time-synchronous data during transmission in a packet data network,
several time-synchronous links existing in the packet data network and
data packets of a link periodically being sent with the spacing of a period duration in a recurrent manner.

The invention further relates to a device for packeting time-synchronous data in a packet data network, comprising
means for packeting several time-synchronous links and
means for periodically sending data packets of a link with the spacing of a period duration in a recurrent manner.

### BACKGROUND OF THE INVENTION

Nowadays time-synchronous links, i.e. links where the data is present at the recipient end in the same chronological order as at the sender end, via packet-switching data networks are being used ever more frequently. Because of the travel time of the packets the data is naturally delayed, but it is essential that the chronological order is maintained. Examples of time-synchronized links include voice links in the field of telephony as well as video links, for example when consuming a television program via the internet.

Present-day data networks generally have significantly more bandwidth than would be necessary for a link. Data transmission therefore takes place in data packets which are periodically transmitted with the spacing of a packeting time in a recurrent manner. In this case during data transmission of several links accumulations of data packets can occur over time, since in the prior art the packets are generated and transmitted randomly, in other words immediately after the request, which cannot be influenced by the transmission system, to set up a link on the part of a user. Another reason for the accumulation of data packets is for instance a system clock which results in it being possible to generate or transmit a data packet only at set times. Depending on the ratio of clock period to the packet data length, synchronization or beat effects can occur here.

Unlike with link-oriented communication networks, in which the PCM30 system is used for example, data transmission cannot take place without any delay on the part of a data-concentrating network element in a packet data network if blocks of data packets, known as “bursts”, occur simultaneously on several transmission paths and several transmission paths are combined onto one transmission path. If in fact the bandwidth on the one outgoing transmission path is not sufficient for the transmission of the incoming data burst, data has to be buffered and forwarded with a delay, as soon as free bandwidth is available again. The situation described also occurs in the case of routers.

In a link-oriented communication network such phenomena cannot occur because of the engineering design, since for example in a PCM30 system all concentrating elements are designed for the processing of all existing links. New links are not in fact set up in such a communication network in the event of overload. In a packet-switching data network an occasional overload of individual network components can however occur, as already shown.

However, as short delay times as possible during data transmission represent a decisive quality criterion when evaluating time-synchronous links, since delays in a telephone call for instance are extremely disruptive for the calling parties, as soon as particular tolerance limits are exceeded. If the data is now delayed because of the situation described, in particular multiply, on network elements, it may no longer be possible to adhere to the quality criteria demanded.

### SUMMARY OF THE INVENTION

The object of the invention is thus to specify a method and a device that delay the data packets less in the event of data concentration.

This occurs according to the invention with a method of the type referred to in the introduction, in which the start of data transmission of a link is selected such that the data packets of the different links are as evenly distributed as possible in relation to time.

When setting up a new link the system waits for a favorable point in time to insert a data packet of the new link into a stream of data packets of existing links. This means that the start of data transmission is delayed for a corresponding length of time. The delay time for voice systems is thus in the range of a few milliseconds and can hence be ignored in practice. The slight disadvantage that the start of data transmission is delayed is more than offset by the virtually equal distribution of the data packets which can be achieved thereby. If transmission paths with this type of distributed data packets are combined onto one transmission-path, the absence of “bursts” means in fact that the associated effects are avoided and little or no delays of data packets occur.

In the simplest case only one packeting time is used in a system. For the inventive method and the variants thereof the period time in this case corresponds precisely to this one packeting time.

It is favorable if the period duration in relation to the time characteristic is constant. Particularly simple conditions for the implementation of the inventive method exist here. The technology underlying this variant can hence likewise be configured simply and thus in a fail-safe manner.

An advantageous variant of the invention also occurs with a method,
in which a time interval corresponding to the period duration is split into a number of equal-sized time slots, said number corresponding to the number of possible links,
in which a time slot is permanently assigned to each possible link and
in which when setting up a new link the start of data transmission is selected such that a new data packet is inserted into the time slot corresponding to this link.

A permanent assignment between a link and a reserved time slot is thus found here, it also being possible to assign several possible links to one time slot. This is a particularly simple method for producing an equal distribution. It is also conceivable here that empirical values are included in the assignment table. Thus for example the telephony behavior of users can be evaluated and then forecast, in order at any time to achieve as even as possible a distribution of data packets.

Another advantageous variant of the invention occurs with a method
in which several different packeting times are used in one system and
in which the largest common divisor of all packeting times is selected as the period duration.

In a transmission system the packeting time, thus the time difference between two packets of a link, is not obligatorily equally sized for all links. Thus voice links of varying quality, in other words with different data transmission rates, can be offered by an operator of a communication network. When the packet data length is constant, only the packeting time varies, in other words packets are transmitted more frequently or less frequently. If the various packeting times in a system are selected such that each packeting time is an integer multiple of the period duration, the inventive method can also be used for such systems. A prerequisite for this is thus that the largest common divisor of the several different packeting times is selected as the period duration for which the method steps are executed.

The maximum number of links for a time slot is obtained here by dividing the packeting time assigned to the time slot by the period duration. In this case the packets of the different links which have a common time slot are displaced by the period duration. If a time slot for example is used for two different links, this produces an alternating sequence of packets of the first and second link in this time slot.

It is particularly advantageous
if when setting up a new link the time spacings between the data packets of the different links are evaluated within a time interval corresponding to the period duration and
if the start of data transmission of the new link is selected such that a new data packet is inserted into the largest time gap between the already existing data packets.

This variant of the invention enables optimum even distribution of data packets without having to take users' behavior into account. Assuming a particular distribution of data packets a data packet of a new link is inserted into the respective largest time gap between data packets of two existing links, so that the data packets are largely evenly distributed at any point in time. New gaps can occur here for example because links are cleared down. When setting up another new link this gap is however quickly filled up again by the inventive method.

It is favorable here if the gap is divided into two equally sized parts. Here a packet of a new link is placed into the middle of a gap in order to produce an optimum even distribution.

It is also particularly advantageous
if a time interval corresponding to the period duration is divided into a number of equally sized time slots corresponding to the number of possible links and
if when setting up a new link the start time of data transmission is rounded such that a new data packet is inserted into a time slot.

If data packets are inserted into an existing data stream at any point in time, in general differently sized gaps arise. When inserting new data packets it can hence occur that no sufficiently large gap for this is found. In this case packets of existing links must be delayed in order to create a suitable gap.

In order to avoid this problem, a time interval corresponding to the period duration, said time interval being continuously repeated because of the periodicity, is divided according to the invention such that the data packets are evenly spaced from one another when there is a full load. If in the event of a partial load a packet of a new link is now inserted, the delay time until the start of a data transmission is now rounded so that a packet fits exactly into an intended time slot. At maximum use of the system the data packets of the different links hence follow directly one after the other, as a result of which particularly good use can be made of the resources here.

Another advantageous variant of the invention is a method
in which several different packeting times are used in a system,
in which the largest common divisor of all packeting times is selected as the period duration and
in which during the evaluation of the time spacings between the data packets of the different links within a time interval corresponding to the period duration, those links to which no data packet is being transmitted in the time interval under consideration are also taken into account.

Here again reference is made to a transmission system in which the packeting time for different links is of different sizes. If the different packeting times in a system are selected such that an integer multiple of the period duration is selected for each packeting time, the inventive method can also be used for such systems. A prerequisite for this is thus that the largest common divisor of the several different packeting times is selected as the period duration and that when evaluating the time spacings between the data packets those links to which no data packet is being transmitted in the time interval under consideration are also taken into account. By taking into account all links present in a system, collisions of data packets of different links can in fact be effectively prevented.

When using different packeting times one time slot can as already mentioned also be used here for different links. The maximum number of links for a time slot is again obtained by dividing the packeting time by the period duration. In this case the packets of the different links which have a common time slot are displaced by the period duration as already mentioned.

The object of the invention is also achieved by a device of the type referred to in the introduction, which additionally has means for starting data transmission of a link, such that the data packets of the different links are as evenly distributed as possible in relation to time.

The start of data transmission is, as already mentioned, correspondingly delayed in order thus to produce a largely even distribution of the data packets of different links. If transmission paths with this type of distributed data packets are combined onto one transmission path, the absence of “bursts” avoids the associated effects and little or no delay to data packets occurs.

A device is favorable here which comprises
means for dividing a time interval corresponding to the period time into a number of equally sized time slots corresponding to the number of possible links,
means for the permanent assignment of each possible link to a time slot and
means for starting data transmission of a new link, such that a new data packet is inserted into the time slot corresponding to this link.

Crucial for this variant of the invention is a permanent assignment between a link and a reserved time slot, whereby several possible links can be assigned to one time slot. This permits a particularly simple device for producing an even distribution of the data. It is also conceivable here to use an assignment table, in which empirical values about the telephony behavior of the users are included.

When using different packeting times one time slot can also be used here as already mentioned for different links. The maximum number of links for a time slot is again obtained here by dividing the packeting time by the period duration.

Finally, a device is particularly advantageous which comprises
means for evaluating the time spacings between the data packets of the different links within a time interval corresponding to the period duration and
means for starting data transmission of a new link such that a new data packet is inserted into the largest time gap between the already existing data packets.

This device enables the optimum even distribution of data packets without having to take account of users' behavior. Assuming a particular distribution of data packets a data packet of a new link, as already mentioned, is inserted into the respectively largest time gap between data packets of two existing links, so that the data packets are largely evenly distributed at any point in time.

Reference is also made to the fact that the variants and advantages referred to for the inventive method can equally also be applied to the inventive device.

### BRIEF DESCRIPTION OF THE DRAWINGS

The invention will now be described in greater detail on the basis of an exemplary embodiment illustrated in the figures.

The drawing show:

FIG. 1: the combination of two transmission paths onto one transmission path according to the prior art;

FIG. 2: the inventive insertion of a data packet of a new link into an existing system;

FIG. 3: a system with directly consecutive time slots at different points in time;

FIG. 4: the combination of two transmission paths with inventive even distribution of the data packets onto one transmission path;

FIG. 5: a system in which different packeting times are used for different links;

FIG. 6: a system in which several links are assigned to one time slot.

### DETAILED DESCRIPTION OF THE INVENTION

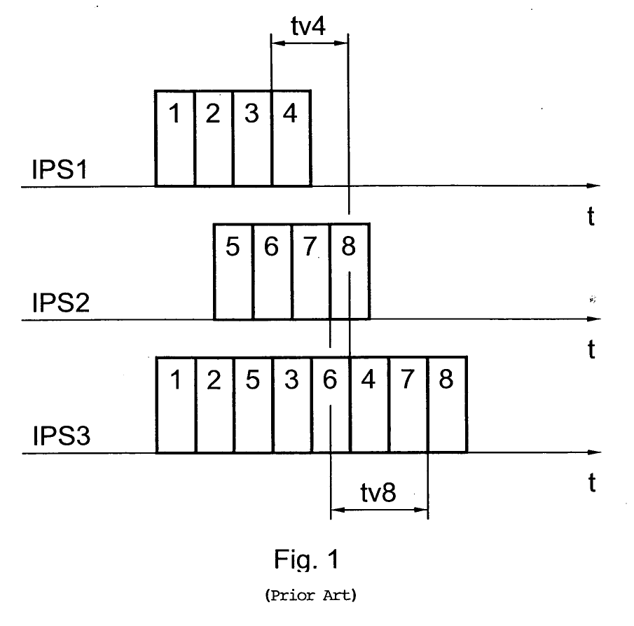

FIG. 1 shows the combination of two transmission paths onto one transmission path according to the prior art. In this case data packets of a first to fourth link 1..4 are transmitted on a first transmission path IPS1 and data packets of a fifth to eighth link 5..8 are transmitted on a second transmission path IPS2. The first and second transmission path IPS1 and IPS2 are—for example in a switching node—combined to form a third transmission path IPS3. FIG. 1 shows the distribution of the data packets over time there.

In the following, for the sake of simplicity it is assumed that the data packets are transmitted without any delay. Furthermore it is noted that the packeting time in the example shown is bigger than the time excerpt shown, so that in each case only one data packet can be seen for a link. It is readily apparent that the data packets in the example shown occur in blocks and that a time overlap of the packets occurs on the first and the second transmission path IPS1 and IPS2.

When the first and the second transmission path IPS1 and IPS2 are combined, the data packet of the first link 1 is first transmitted into the third transmission path IPS3. The data packet of the second link 2 follows immediately. A conflict arises here in that in some cases the data packet of the fifth link 5 is already awaiting transmission. However, this is delayed and is not transmitted until after the data packet of the second link 2. Subsequently in each case a data packet is extracted alternately from the first and from the second transmission path IPS1 and IPS2 and is transmitted into the third transmission path IPS3, for as long as a time overlap of the packets is present. The sequence for the third transmission path is thus 1 2 5 3 6 4 7 8. The time delay of different data packets is readily apparent in FIG. 1. Thus for example the delay times tv4 and tv8 are entered for the data packets of the fourth and eighth link 4 and 8.

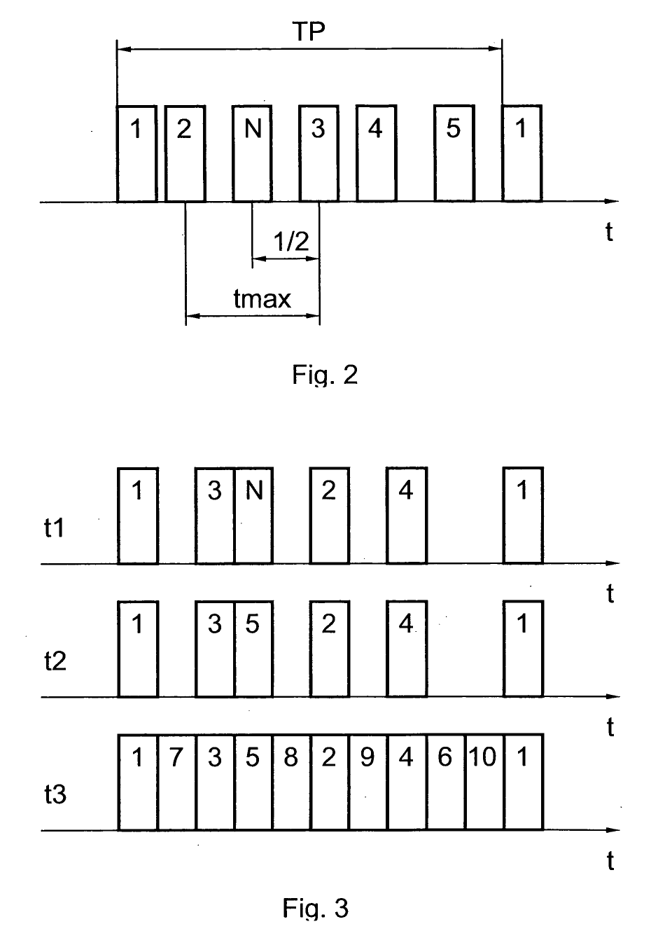

FIG. 2 shows a variant of the inventive method, whereby here a full period of the transmission of the data packets can be seen for the first link 1. The period duration TP is inserted for the first link 1 for this purpose. In the following, for the sake of simplicity it is assumed that the packeting time TPA is of equal size for all links and thus is the same as the period duration TP. For the purposes of FIG. 2 the operations in an individual transmission path are considered in isolation.

Data packets of the first to fifth link 1..5 are entered on the time line t, with differently sized time spacings between the data packets being apparent. The resulting pattern repeats itself periodically at the interval of the period duration TP, assuming constant circumstances. A new link N is then set up, as a result of which the associated data packets are inserted into the time sequence. To this end the largest time interval between two data packets tmax is determined. In the case shown, the largest gap is between the data packets of the second and the third link 2 and 3. The data packet of the new link N is hence inserted into this gap, preferably in the middle of the gap tmax/2. In this way a largely even time distribution of the data packets is always achieved. For this purpose the start of data transmission is delayed for a corresponding length of time when setting up a new link N. The delay time is here in the range of a few milliseconds for voice systems and hence can be ignored in practice.

FIG. 3 shows a system similar to FIG. 2 at a first to third point in time t1..t3. In contrast to the system in FIG. 2, a time interval corresponding to the period duration TP is divided into a number, here 10, of equally sized time slots, said number corresponding to the number of possible links, and a data packet is inserted into one of these time slots if required. This has the advantage that the data packets of the different links are optimally evenly distributed at full load. When a transmission path is being used to the full, as shown at the point in time t3, the data packets of the different links follow one another directly without time gaps. This optimum even distribution is not obligatorily the case in a system according to FIG. 2.

At a first point in time t1 data packets of a first to fourth link 1..4 can be seen. It can also be seen that a data packet of a new link N is inserted into the system. For the link in question the index 5 is hence inserted at point in time t2. The representation at the third point in time t3 shows the system now at full load. Based on the sequence of indices for the different links 1 7 3 5 8 2 9 4 6 10 1 it is readily apparent in what time sequence the packets have been inserted into the system.

It is noted that the system illustrated in FIG. 3 does not differ at full load from a system in which a time slot is permanently assigned to each link, since the even distribution of the data packets is automatically provided for here. However, at partial load an uneven distribution of the packets is indeed very possible in a system with fixed assignments.

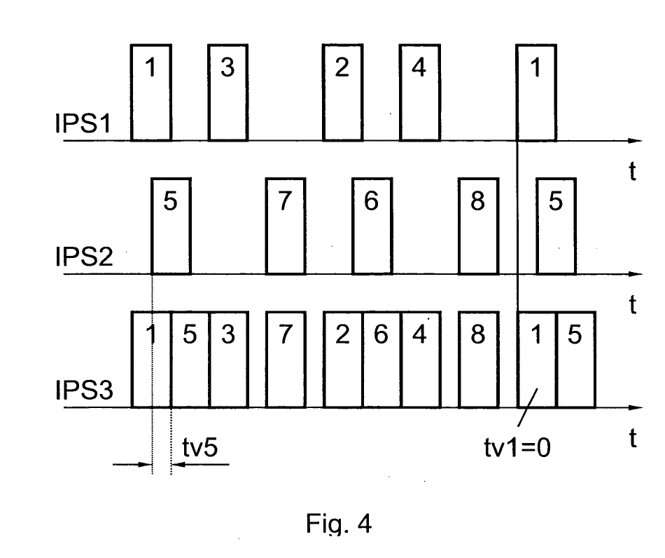

FIG. 4 now shows the combination of two transmission paths with inventive even distribution of the data packets onto one transmission path. In this case-as in FIG. 1 data packets of a first to fourth link 1..4 are transmitted on a first transmission path IPS1 and data packets of a fifth to eighth link 5..8 on a second transmission path IPS2. The first and second transmission path IPS1 and IPS2 are again combined to form a third transmission path IPS3.

In contrast to FIG. 1 the period duration TP or packeting time TPA in the example shown is not bigger than the time excerpt shown, so that for the first and the fifth link 1 and 5 two data packets can be seen in each case. The even distribution of the packets and the time overlap of some packets on the first and the second transmission path IPS1 and IPS2 is readily apparent. It is also noted that the circumstances in the figures reflect the real facts only insufficiently, since the packeting time is generally considerably larger than the packet length and thus significantly more links than illustrated can be switched.

When considering the combination of the first and second transmission path IPS1 and IPS2 a start is made with a data packet of the first link 1, which is transmitted without any delay into the third transmission path IPS3. It is followed by the data packet of the fifth link 5, a conflict with the data packet of the first link 1 occurring as a result of the time overlap. The data packet of the fifth link 5 is hence transmitted with a delay. Assuming that in the event of a time overlap data packets which are received first are given priority, the sequence produced for the third transmission path IPS3 is 1 5 3 7 2 6 4 8. The principle for ordering referred to is also known by the term “first in first out”.

In FIG. 4 the time delay of different packets is again readily apparent. Thus for example for the data packet of the first link 1 the delay time tv1=0 is inserted, for the fifth link 5 the delay time tv5. With reference to FIG. 1 the advantage of the inventive method becomes particularly clear here. Whereas in FIG. 1 for example the data packets of the fourth and eighth link 4 and 8 are crucially delayed, the data packets in the system illustrated in FIG. 4 are subject to little or no delay. As short a delay time as possible is in this case an important quality criterion when evaluating time-synchronous links, such as in telephone links via packet-switching networks.

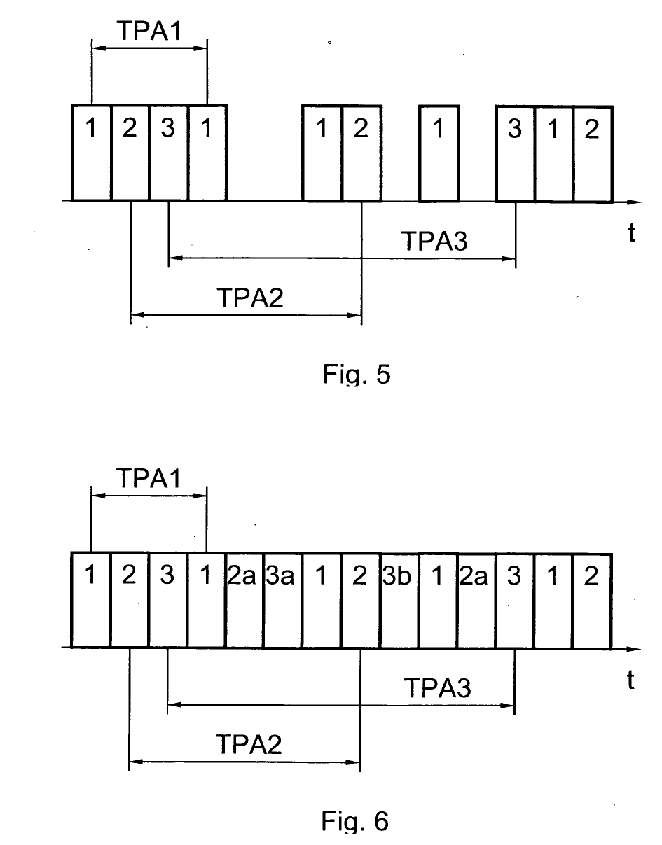

Finally, FIG. 5 illustrates a system in which different packeting times TPA are used for different links. Data packets of a first link 1 can be seen which are periodically transmitted with the spacing of a first packeting time TPA1. In the gaps that arise packets of other links are now also transmitted, namely packets of a second link 2, which are transmitted with the spacing of a second packeting time TPA2, and packets of a third link 3, which are transmitted with the spacing of a third packeting time TPA3. To prevent collisions it should be noted here that each packeting time TPA must be an integer multiple of the period duration TP. Hence in the case shown the period duration TP is equal to the first packeting time TPA1, since this represents the largest common divisor of all packeting times TPA1..TPA3 present in the system. For using the inventive method it should further be noted that when executing the method steps all existing links 1..3 must be taken into account, even if in the time interval under consideration no data packet is being transmitted to specific links 1..3. For example, if the method was used without taking account of the second interval shown in FIG. 5, a data packet of a new link would be inserted in the middle of the free gap, which in a subsequent interval would inevitably result in a collision with data packets of the second link 2 and/or of the third link 3.

Data packets of other links can be inserted into the gaps which can be seen in the sequence of data packets illustrated in FIG. 5. It should be noted here that packeting times TPA must not be mixed in a particular time slot. That means that it is essential that for the second time slot the second packeting time TPA2 is used, and for the third time slot the third packeting time TPA3. Hence a data packet of a further second link 2a can be inserted into the second time slot, and hence data packets of two further third links 3a and 3b into the third time slot. This sequence is illustrated in FIG. 6.

1-7. (canceled)

8. A method for packeting time-synchronous data during a transmission in a packet data network having a plurality of links, comprising:
recurrently transmitting a plurality of data packets of the links in a period duration;
selecting a plurality of start time of data transmission of the links so that the data packets of the links substantially evenly distribute with respect to time;
dividing a time interval corresponding to the period duration into a plurality of equally sized time slots corresponding to a plurality of possible links;
permanently assigning one of the time slots to one of the possible links;
selecting a start time of a data transmission of a new link so that a new data packet of the new link is inserted into the one permanently assigned time slot corresponding to the one possible link; and
selecting a largest common divisor of a plurality of different packeting times as the period duration if the plurality of different packeting times are used in a transmission system.

9. The method as claimed in claim 8,
wherein when setting up the new link a plurality of time gaps between the data packets of the links are evaluated within the time interval corresponding to the period duration,
wherein the start time of data transmission of the new link is selected so that the new data packet of the new link is inserted into a largest time gap between the data packets.

10. The method as claimed in claim 9, wherein the largest time gap is divided into two equally sized parts.

11. The method as claimed in claim 9, wherein the new data packet of the new link is inserted into a middle of the largest time gap between the data packets.

12. The method as claimed in claim 9,
wherein the time interval corresponding to the period duration is divided into a plurality of equally sized time slots corresponding to a plurality of possible links,
wherein when setting up a new link a start time of data transmission is rounded so that the new data packet of the new link is inserted into a time slot.

13. The method as claimed in claim 9,
wherein if a plurality of different packeting times are used in a system, a largest common divisor of the different packeting times is selected as the period duration and,
wherein when evaluating the time gaps between the data packets of the different links within a time interval corresponding to the period duration, links which have no data packet being transmitted in the time interval are also considered.

14. The method as claimed in claim 8, wherein the links in the packet data network are time-synchronous links.

15. A device for packeting time-synchronous data in a packet data network having a plurality of links, comprising:
a data packeting device for packeting a plurality of links;
a transmitter for recurrently transmitting a plurality of data packets of the links with a period duration;
a first selector for selecting a plurality of start time of data transmission of the links so that the data packets of the links substantially evenly distribute with respect to time;
a calculator for dividing a time interval corresponding to the period duration into a plurality of equally sized time slots corresponding to a plurality of possible links;
an assignment device for permanently assigning one of the time slot to one of the possible links; and
a second selector for selecting a start time of data transmission of a new link so that a new data packet of the new link is inserted into the one permanently assigned time slot corresponding to the one possible link.

16. The device as claimed in claim 15,
wherein when setting up the new link a plurality of time gaps between the data packets of the links are evaluated within a time interval corresponding to the period duration,
wherein the start time of data transmission of the new link is selected so that a new data packet is inserted into a largest time gap between the data packets.

17. The device as claimed in claim 15, wherein if a plurality of different packeting times are used in a transmission system, a largest common divisor of the different packeting times is selected as the period duration.

18. The device as claimed in claim 15, wherein the links in the packet data network are time-synchronous links.

19. A device for packeting time-synchronous data in a packet data network having a plurality of links, comprising:
a data packeting device for packeting a plurality of links;
a transmitter for periodically recurrently transmitting a plurality of data packets of the links with a period duration;
a first selector for selecting a plurality of start time of data transmission of the links so that the data packets of the links substantially evenly distribute with respect to time;
a calculator for dividing a time interval corresponding to the period duration into a plurality of equally sized time slots corresponding to a plurality of possible links;
an assignment device for permanently assigning one of the time slot to one of the possible links;
a second selector for selecting a start time of a data transmission of a new link so that a new data packet of the new link is inserted into the one permanently assigned time slot corresponding to the one possible link; and
a third selector for selecting a largest common divisor of a plurality of different packeting times as the period duration if the plurality of different packeting times are used in a transmission system.
